(19) United States
(12) Patent Application Publication
(10) Pub. No.: US 2005/0276383 A1
(43) Pub. Date: Dec. 15, 2005

(54) Detector drawer for a mobile detector

(76) Inventors: Carsten Bertram, Erlangen (DE); Thomas Schmitt, Forchheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/939,316

(22) Filed: Sep. 10, 2004

(30) Foreign Application Priority Data
Sep. 10, 2003 (DE) 10342080.0

(51) Int. Cl. G03B 42/02

(52) U.S. Cl. 378/181

(57) ABSTRACT

A detector drawer for a solid-state detector can be moved in the detector drawer normal to its direction of travel under a patient table. The detector drawer (4) is designed to accommodate, in a manner allowing easy detachment and removal, a mobile, portable detector (13) preferably provided with a handle (15) and having a connecting cable. The mobile detector (13) can be inserted into the detector drawer from two opposite sides of the patient table (3).

### CROSS REFERENCE TO RELATED APPLICATIONS

This application claims priority to the German application No. 10342080.0, filed Sep. 10, 2003 and which is incorporated by reference herein in its entirety.

### FIELD OF INVENTION

The invention relates to a detector drawer for a solid-state detector that can be moved in the detector drawer normal to its direction of travel under a patient table.

### BACKGROUND OF INVENTION

In addition to arrangements having permanently built-in solid-state detectors, detector drawers are already known, for instance see DE 197 07 021 A1, in which the actual solid-state detector can be pulled out normal to the direction of travel and which may also be arranged to allow tilting so that it can be brought into a vertical position in which lateral images of the extremities become possible.

### SUMMARY OF INVENTION

WO 01/33921 A1 discloses a detector drawer in which the additionally described rotational capability of the built-in solid-state detector cannot be implemented for space reasons.

Nowadays, for applications which cannot be reached with these devices, one often uses mobile detectors i.e. detectors equipped with a handle and a connecting cable so that they can be taken anywhere and connected to the respective device electronics using the connecting cable.

Such mobile detectors are very expensive, however, as are the permanently built-in solid-state detectors of course, so it is very costly to use two solid-state detectors when operating an X-ray device and uneconomic for many applications.

The arrangement described in DE 101 18 745 C2 is only suitable for detectors without a cable connection which are not available as yet.

It is therefore an object of the invention to design a detector drawer in such a way that the need to use more than one detector can be avoided.

This object is achieved by the claims.

Thus according to the invention, a solid-state detector is no longer built into the detector drawer at all, but only the conditions for accommodating a mobile detector are created so that said mobile detector can be inserted and then operated optionally like a permanently built-in solid-state detector or else as a mobile detector in the known way after removal.

Of particular importance here is not just the capability of inserting a mobile detector in a specially designed detector drawer, but the capability of inserting such a detector equipped with a connecting cable from both sides of the patient resting table. In practice mobile detectors without cables are neither available nor able to be used in the foreseeable future because not only are they extraordinarily expensive but there is the risk that the transmission electronics (bluetooth or the like) will interfere with other systems in the examination room and the actual X-ray device itself, so that at present only detectors are used that are equipped with a connecting cable of about 7 m in length that is plugged into a connection box on the underside of the patient resting table. This cable is still a nuisance when a patient wants to get on or off the table or when several members of the operating staff or several doctors need to stand on this side during any operations, so that in such cases it is practical if one arranges the cable on the other side of the table. This makes it necessary to design the detector drawer so that the mobile detector can be inserted from either side. The side of the patient resting table on which the cable interferes with operation is always switching from one side to the other because changing requirements and other equipment standing beside the patient resting table make it necessary to perform operating tasks sometimes on one side and sometimes on the other, and for the patient to get on or off sometimes on one side and sometimes on the other.

In a further development of the invention, it can be provided that a carrier plate for accommodating the mobile detector is carried, in a manner allowing transverse movement, in a detector frame, which is open normal to the direction of travel, having side flange walls, possibly carrying a grid and an Iontomat offset from the frame base.

The carrier plate is first pulled out in order to insert the detector and the detector laid in place and then the carrier plate is pushed back into the detector frame, the open design of the detector frame on two sides enabling the detector to be inserted from either side of the patient resting table. In contrast with solid-state detectors that until now could only be pulled out of catapult grid drawers from one side, this is advantageous in many applications in which side access to the patient resting table is restricted. For other purposes, namely where radiographic examinations are not purely from above, the mobile detector can be removed simply by pulling out the carrier plate and used in a suitable location, for example on a wall-mounted grid device or for taking images from any position.

The carrier plate can also usefully be provided with hand holes extending outwards beyond the detector frame on both insertion sides.

Finally, the invention also includes the fact that the detector drawer is designed to be larger than the portable detector and said detector can be variously positioned in it centrally, off-center or at an angle.

### BRIEF DESCRIPTION OF THE DRAWINGS

Further advantages, features and details of the invention follow from the description below of an exemplary embodiment and from the drawing, in which

FIG. 1 shows a schematic view of an X-ray system having a detector drawer according to the invention,

FIG. 2 shows the schematic design of the detector drawer according to the invention for a mobile detector,

FIG. 3 shows a schematic cross-section along the line III-III through the detector drawer containing built-in grid Iontomat and inserted mobile solid-state detector, and

FIG. 4a to 4d show possible positions of the mobile detector on the carrier plate.

### DEATAILED DESCRIPTION OF INVENTION

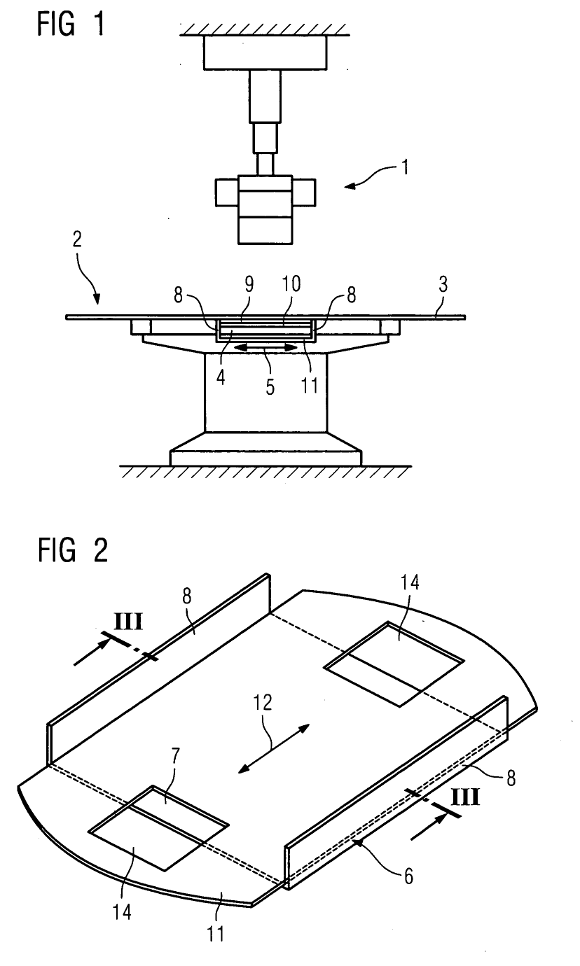

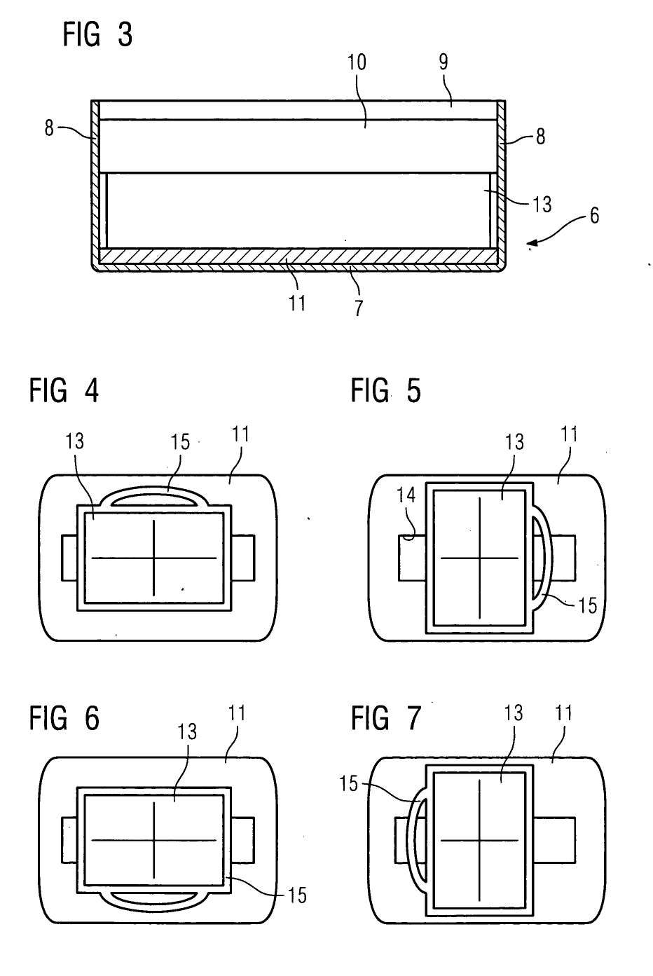

FIG. 1 shows schematically an X-ray arrangement having an X-ray source 1 and an adjustable patient resting table 2 arranged below this, under whose resting surface 3 is arranged a detector drawer 4 for a mobile solid-state detector. Here the detector drawer 4 is arranged in a manner allowing movement in the direction of the double arrow 5 i.e. in the longitudinal direction of the resting surface 3, so that it can be brought under different body areas of the patient lying on the surface. Instead of the hitherto common arrangement having a permanently installed solid-state detector, according to the invention a U-shaped detector frame 6 open on two opposite sides is provided, whose side flange walls 8 standing upright from the frame base 7 are provided with retaining devices in order to hold, offset from the frame base 7, a grid 9, which may be movable, and to hold below this a measurement chamber 10 (Iontomat) offset from the frame base. A carrier plate 11 which can move on the frame base 7 normal to the direction of travel 9 of the detector drawer and can be pulled out on either side (see double arrow 12), serves to accommodate and to hold in a centered position a standard commercial mobile detector that can be placed on it. This standard commercial mobile detector 13 can be positioned on the support plate in various ways as shown in FIGS. 4a to 4d, where apart from the illustrated positions, the detector may also be positioned at an angle or with an asymmetric offset. The retaining devices for fixing the mobile detector 13 on the carrier plate 11 are not shown for the sake of clarity.

The carrier plate 11 is provided with hand holes 14 on both insertion sides, which form handles that extend outwards beyond the detector frame 6, as one can see in particular from FIG. 2, so that they can be grasped very easily from either side of the patient resting table and accordingly the carrier plate can be pulled out in order to accommodate a mobile detector or in order to remove the inserted mobile detector for other purposes.

The detector 13 is equipped with a connecting cable 16 that has a length of approximately 7 meters typical of today's portable detectors, and that can be plugged into the connection box on the underside of the patient resting table 2. This down-hanging cable causes a nuisance to the operating staff, however, and in particular to the patients when mounting the patient resting table (although arrangements using wireless transmission are conceivable in theory, the associated problems and risk of interference with the other system electronics means that currently there is no chance of using them). By the detector drawer 4 being designed according to the invention, such that the mobile detector can be inserted from two opposite sides of the patient resting table so that the cable projects optionally from one or the other side, the detector can be inserted so that the cable projects from the side on which the patient does not mount or descend from the patient resting table. This side varies depending on where the system is standing and what other equipment is arranged around the patient resting table beneath the X-ray device 1.

A traditional film cassette or imaging plate cassette could also be inserted as an alternative to the detector 13.

1-4. (canceled)

5. A detector drawer for a solid-state detector, the detector being adapted to move transverse to its direction of travel in the detector drawer under a patient table, comprising:
a mechanism for accommodating a mobile portable detector having a connecting cable, wherein
the mechanism is adapted for an easy removal of the portable detector; and wherein
the mechanism is adapted for inserting the mobile detector from two opposite sides of the patient table.

6. The detector drawer according to claim 1, wherein the portable detector is provided with a handle.

7. The detector drawer according to claim 1, further comprising:
a carrier plate adapted to accommodate the mobile detector, wherein
the carrier plate is arranged in a detector frame having side flange walls, wherein
the detector frame is open transverse to the direction of travel, and wherein
the carrier plate is adapted for transverse movement.

8. The detector according to claim 7, wherein the side flange walls carry a grid and a metering chamber arranged at a distance from the frame base.

9. The detector according to claim 8, wherein the metering chamber is an Iontomat.

10. The detector drawer according to claim 7, wherein the carrier accommodation plate is provided with recesses extending outwards beyond the detector frame on both insertion sides.

11. The detector drawer according to claim 10, wherein the recesses are used as hand holes.

12. The detector drawer according to claim 5, wherein
the detector drawer has a larger capacity as compared to the capacity necessary for accommodating the detector, and wherein
the detector drawer is adapted for arranging the detector any of centrally, off-center and at an angle.

13. A detector drawer for holding a solid-state portable medical detector under a medical table having a connecting cable, comprising:
a base sized and configured to be larger than the detector;
a pair of opposing walls extending vertically from the base; and
a pair of opposing wall extending horizontally from the base,
wherein the detector can be inserted into the drawer from the direction of either of the horizontally extending walls,
wherein the drawer is adapted to move in a direction substantially parallel to the direction that the patient is lying on the medical table.

14. The detector drawer according claim 13, wherein the opposing horizontally extending walls are integrally formed with the base.

15. The detector drawer according claim 13, wherein a recess is formed in the base.

16. The detector drawer according claim 13, wherein a recess is formed in each of the opposing horizontally extending walls.
